(19) United States
(12) Patent Application Publication
(10) Pub. No.: US 2026/0330645 A1
(43) Pub. Date: Oct. 22, 2026

(54) EDGE IMAGE ACQUISITION APPARATUS AND EDGE IMAGE ACQUISITION METHOD

(71) Applicant: HAMAMATSU PHOTONICS K.K., Hamamatsu-shi (JP)

(72) Inventors: Katsuhiro NAKAMOTO, Shizuoka (JP); Arisa NIITSUMA, Shizuoka (JP)

(73) Assignee: HAMAMATSU PHOTONICS K.K., Hamamatsu-shi (JP)

(21) Appl. No.: 19/639,645

(22) Filed: Apr. 6, 2026

(30) Foreign Application Priority Data
Apr. 22, 2025 (JP) 2025-070135

(51) Int. Cl. G06T 7/174; G06T 7/13; H04N 23/55

(52) U.S. Cl. CPC G06T 7/174; G06T 7/13; H04N 23/55; G06T 2207/10004

(57) ABSTRACT

An edge image acquisition apparatus includes a light source, a spatial light modulator, a photodetector, and a control unit. The control unit uses a reference pattern in which an intensity modulation amount of light in each of a plurality of pixels two-dimensionally arranged is randomly set. The control unit sequentially sets a spatial intensity modulation pattern by the spatial light modulator to each of a plurality of patterns by sequentially setting a relative position of the reference pattern with respect to an object to each of a plurality of positions. The control unit acquires an light intensity detected by the photodetector in a period in which the spatial intensity modulation pattern is set to each of the plurality of patterns, and obtains an image and an edge image of the object by using ghost imaging based on the light intensities and the plurality of patterns.

### CROSS-REFERENCE TO RELATED APPLICATION

This application is based upon and claims the benefit of priority from Japanese Patent Application No. 2025-070135, filed on Apr. 22, 2025, the entire contents of which are incorporated herein by reference.

### TECHNICAL FIELD

The present disclosure relates to an edge image acquisition apparatus and an edge image acquisition method for acquire an edge image of an object by using ghost imaging.

### BACKGROUND

Non Patent Document 1 describes a technique for acquiring an image of an object by using ghost imaging. In the ghost imaging technique, a spatial light modulator and the object are arranged on an optical path between a light source and a photodetector, a spatial intensity modulation pattern of light by the spatial light modulator is sequentially set to each of a plurality of patterns different from each other, a light intensity detected by the photodetector in a period in which the spatial intensity modulation pattern is set to each of the plurality of patterns is acquired, and the image of the object is obtained based on a correlation calculation between each pattern and each light intensity.

The photodetector which is used in the ghost imaging technique may be a photodetector of a single pixel (a point sensor). Therefore, even in a wavelength region in which it is difficult to acquire a two-dimensional image by using an area sensor in which a plurality of pixels are two-dimensionally arranged, when the point sensor having light receiving sensitivity in the above wavelength region exists, the two-dimensional image of the object can be acquired by the ghost imaging by using the point sensor.

By performing mathematical processing on the image of the object, an edge image which emphasizes an outline of the object can be acquired. The edge image is utilized for position detection, size measurement, outer shape inspection, and the like of the object, and is useful in industrial application. As the mathematical processing performed for generating the edge image from the original image, several processes are known, and further, in the following description, differential processing is described in which a convolution operation of a kernel as a differential operator is performed on the original image.

Even in the wavelength region in which it is difficult to acquire the two-dimensional image by using the area sensor, by using the point sensor having the light receiving sensitivity in the above wavelength region, the two-dimensional image of the object can be acquired by using the ghost imaging technique described in Non Patent Document 1. Further, by performing the convolution operation of the kernel on the image, a two-dimensional edge image of the object can be acquired. The technique of acquiring the edge image in this way is, in the following description, referred to as a “first comparative example”.

Further, Non Patent Document 2 describes a technique for directly acquiring the edge image by using the ghost imaging. In this technique, the light intensity is measured by the photodetector by using the spatial intensity modulation pattern, and in addition, the above pattern is shifted in each of upward, downward, leftward, and rightward directions by a distance which is an integer multiple of a pixel pitch, and the light intensity is similarly measured by the photodetector. Further, by performing a linear operation on a plurality of light intensity values, it is possible to acquire one light intensity in the case in which the above pattern is used to directly perform light irradiation on a differential image of the object.

For each of a large number of patterns different from each other, the light intensity in the case in which the light irradiation is directly performed on the differential image of the object is acquired, and the edge image of the object is obtained based on the correlation calculation between each pattern and each light intensity. The technique of acquiring the edge image in this way is, in the following description, referred to as a “second comparative example”.
Non Patent Document 1: Andrew M. Kingston et al., “Optimizing nonconfigurable, transversely displaced masks for illumination patterns in classical ghost imaging”, Physical Review A 107, 2, 023524 (2023)
Non Patent Document 2: Tianyi Mao et al., “Speckle-Shifting Ghost Imaging”, IEEE Photonics Journal, Vol. 8, No. 4, 6900810 (2016)
Non Patent Document 3: David Ceddia and David M. Paganin, “Random-matrix bases, ghost imaging, and x-ray phase contrast computational ghost imaging”, Physical Review A 97, 6, 062119 (2018)
Non Patent Document 4: Katsuhiro Nakamoto, “Prior-image-filtered ghost imaging”, Optics Express, Vol. 33, pp. 3177-3194 (2025)

### SUMMARY

The present inventors have conducted a study on a squared error (a variance) included in each pixel value of the edge image acquired in each of the first comparative example and the second comparative example, and have obtained the following findings.

The ghost imaging technique described in Non Patent Document 1 performs an orthogonal matrix approximation when performing the correlation calculation between each pattern and each light intensity, and thus, even under an ideal condition without shot noise, in the case of a finite number M of patterns, the image of the object cannot be completely reconstruct.

Non Patent Document 3 describes that, when a column vector with respective pixel values of the image of the object as elements is set to t, an error due to the orthogonal matrix approximation is approximately represented by the following Formula (1). That is, the error included in each pixel value of an image t* of the object which is acquired by using the ghost imaging technique described in Non Patent Document 1 is a value obtained by dividing the sum of squares of the respective pixel values of the image t by the number M of patterns.

$$\begin{matrix}[ Formula 1 ] & \\ V [ {t}^{*} ] ≃ \frac{{‖ t ‖}_{2}^{2}}{M} & ( 1 )\end{matrix}$$

In addition, in this specification, the column vector t may be referred to as the image t. The same applies to other images and the edge image. The original image of the object is denoted by t, and the corresponding edge image is represented by the following Formula (2). The image of the object acquired by using the ghost imaging is denoted by t*, and the edge image obtained by performing the numerical convolution operation on t* is represented by the following Formula (3). A matrix of the following Formula (4) appearing in the following Formula (2) and Formula (3) is a matrix representing the convolution operation of a kernel h with respect to the image of the object (t or t*) (hereinafter referred to as a “convolution matrix”).

[Formula 2]

∂t (2)

[Formula 3]

∂t* (3)

[Formula 4]

∂ (4)

For the edge image acquired by the first comparative example, the error included in each pixel value is approximately represented by the following Formula (6) by using the sum of squares of the elements of the kernel h (the following Formula (5)). For example, in the case in which the kernel h is set to a 4-neighbor Laplacian filter of a size of 3×3 as represented by the following Formula (7), the value of Formula (5) is 20, and the value of Formula (6) is 20 times the value of the above Formula (1).

$$[ Formula 5 ]$$

$${‖ h ‖}_{F}^{2} \qquad ( 5 )$$

$$[ Formula 6 ]$$

$$V [ \partial {t}^{*} ] ≃ \frac{{‖ h ‖}_{F}^{2} {‖ t ‖}_{2}^{2}}{M} \qquad ( 6 )$$

$$[ Formula 7 ]$$

$$h = [ \begin{matrix}{h}_{1 , 1} & {h}_{1 , 2} & {h}_{1 , 3} \\ {h}_{2 , 1} & {h}_{2 , 2} & {h}_{2 , 3} \\ {h}_{3 , 1} & {h}_{3 , 2} & {h}_{3 , 3}\end{matrix} ] = [ \begin{matrix}0 & 1 & 0 \\ 1 & - 4 & 1 \\ 0 & 1 & 0\end{matrix} ] \qquad ( 7 )$$

In the second comparative example, in the case in which the number of non-zero elements out of the elements of the kernel h is set to K, in order to acquire one light intensity in the case of directly performing the light irradiation on the differential image of the object by using one certain pattern, it is necessary to perform K times of light intensity measurement. For the case of the kernel h represented by the above Formula (7), it is set to K=5. When the number of light intensity measurements is set to M, the above case corresponds to using M/K patterns, and therefore, the error included in each pixel value of the edge image acquired by the second comparative example is approximately represented by the following Formula (8).

$$[ Formula 8 ]$$

$$V [ {( \partial t )}^{*} ] ≃ \frac{K {‖ \partial t ‖}_{2}^{2}}{M} \qquad ( 8 )$$

In many cases, edge extraction processing by the convolution operation is a sparse transform, and therefore, it is expected that there is a relationship of the following Formula (9) between the original image and the edge image. In this case, the second comparative example provides smaller error in each pixel value of the acquired edge image and better image quality than the first comparative example.

$$[ Formula 9 ]$$

$${‖ \partial t ‖}_{2}^{2} ≪ {‖ t ‖}_{2}^{2} \qquad ( 9 )$$

It is desirable that the error in each pixel value of the acquired edge image be further reduced. However, in the second comparative example, in the case in which the number K of non-zero elements of the kernel h is large, the error in each pixel value of the acquired edge image increases and the image quality deteriorates.

An object of the present invention is to provide an edge image acquisition apparatus and an edge image acquisition method capable of acquiring an edge image of an object in which an error is reduced by using ghost imaging.

An embodiment of the present invention is an edge image acquisition apparatus. The edge image acquisition apparatus includes (1) a light source configured to output light; (2) a photodetector configured to detect a light intensity of the light output from the light source and passed through an object; (3) a spatial light modulator provided on an optical path between the light source and the photodetector, and configured to spatially intensity modulate the light; and (4) a control unit configured to sequentially set a spatial intensity modulation pattern of the light by the spatial light modulator to each of a plurality of patterns different from each other, acquire the light intensity detected by the photodetector in a period in which the spatial intensity modulation pattern is set to each of the plurality of patterns, and obtain an image and an edge image of the object by using ghost imaging based on the acquired light intensities and the plurality of patterns, and the control unit is configured to (a) use a reference pattern in which an intensity modulation amount of the light in each of a plurality of pixels two-dimensionally arranged along a first direction and a second direction which are orthogonal to each other is randomly set, (b) sequentially set the spatial intensity modulation pattern to each of the plurality of patterns by sequentially setting a relative position of the reference pattern with respect to the object along the first direction and the second direction to each of a plurality of positions in units of a pixel pitch, acquire the light intensity detected by the photodetector in the period in which the spatial intensity modulation pattern is set to each of the plurality of patterns, and obtain the image of the object by using the ghost imaging based on the acquired light intensities and the plurality of patterns, (c) use a kernel in which, out of a plurality of elements two-dimensionally arranged along the first direction and the second direction, a value of an element at a center position is set to non-zero or zero, a value of each of elements at a distance from the center position along the first direction of a least common multiple of an interval of the relative position in the first direction, and at a distance from the center position along the second direction of a least common multiple of an interval of the relative position in the second direction is set to non-zero or zero, and values of other elements are set to zero, and (d) obtain the edge image of the object by a convolution operation of the image of the object and the kernel.

An embodiment of the present invention is an edge image acquisition method. The edge image acquisition method uses (1) a light source configured to output light; (2) a photodetector configured to detect a light intensity of the light output from the light source and passed through an object; and (3) a spatial light modulator provided on an optical path between the light source and the photodetector, and configured to spatially intensity modulate the light, and (4) the method includes sequentially setting a spatial intensity modulation pattern of the light by the spatial light modulator to each of a plurality of patterns different from each other, acquiring the light intensity detected by the photodetector in a period in which the spatial intensity modulation pattern is set to each of the plurality of patterns, and obtaining an image and an edge image of the object by using ghost imaging based on the acquired light intensities and the plurality of patterns, and (a) a reference pattern in which an intensity modulation amount of the light in each of a plurality of pixels two-dimensionally arranged along a first direction and a second direction which are orthogonal to each other is randomly set is used, (b) the spatial intensity modulation pattern is sequentially set to each of the plurality of patterns by sequentially setting a relative position of the reference pattern with respect to the object along the first direction and the second direction to each of a plurality of positions in units of a pixel pitch, the light intensity detected by the photodetector is acquired in the period in which the spatial intensity modulation pattern is set to each of the plurality of patterns, and the image of the object is obtained by using the ghost imaging based on the acquired light intensities and the plurality of patterns, (c) a kernel in which, out of a plurality of elements two-dimensionally arranged along the first direction and the second direction, a value of an element at a center position is set to non-zero or zero, a value of each of elements at a distance from the center position along the first direction of a least common multiple of an interval of the relative position in the first direction, and at a distance from the center position along the second direction of a least common multiple of an interval of the relative position in the second direction is set to non-zero or zero, and values of other elements are set to zero is used, and (d) the edge image of the object is obtained by a convolution operation of the image of the object and the kernel.

According to the edge image acquisition apparatus and the edge image acquisition method of the embodiments of the present invention, it is possible to acquire an edge image of an object in which an error is reduced by using ghost imaging.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram illustrating a configuration of an edge image acquisition apparatus 1.

FIG. 2 is a diagram illustrating a configuration of an edge image acquisition apparatus 2.

FIG. 3 is a diagram for describing a procedure for creating a convolution matrix from a kernel h.

FIG. 4 is a diagram for describing the procedure for creating the convolution matrix from the kernel h.

FIG. 5 is a diagram for describing a reference pattern.

FIG. 6 is a diagram illustrating an example of a flowchart of an edge image acquisition method.

FIG. 7A to FIG. 7D are diagrams showing results of a first simulation, and are (A) a diagram showing an original edge image of an object, (B) a diagram showing an edge image obtained in a first comparative example, (C) a diagram showing an edge image obtained in a second comparative example, and (D) a diagram showing an edge image obtained by using the edge image acquisition method according to the present embodiment.

FIG. 8 is a graph showing a relationship between the number of measurements and the squared error of each pixel value in the first simulation.

FIG. 9A to FIG. 9D are diagrams showing results of a second simulation, and are (A) a diagram showing an original edge image of the object, (B) a diagram showing an edge image obtained in the first comparative example, (C) a diagram showing an edge image obtained in the second comparative example, and (D) a diagram showing an edge image obtained by using the edge image acquisition method according to the present embodiment.

FIG. 10 is a graph showing a relationship between the number of measurements and the squared error of each pixel value in the second simulation.

FIG. 11A to FIG. 11C are diagrams showing results of a third simulation, and are (A) a diagram showing an edge image obtained in the first comparative example, (B) a diagram showing an edge image obtained in the second comparative example, and (C) a diagram showing an edge image obtained by using the edge image acquisition method according to the present embodiment.

### DETAILED DESCRIPTION

Hereinafter, embodiments of an edge image acquisition apparatus and an edge image acquisition method will be described in detail with reference to the accompanying drawings. In the description of the drawings, the same elements will be denoted by the same reference signs, and redundant description will be omitted. The present invention is not limited to these examples, and the claims, their equivalents, and all the changes within the scope are intended as would fall within the scope of the present invention.

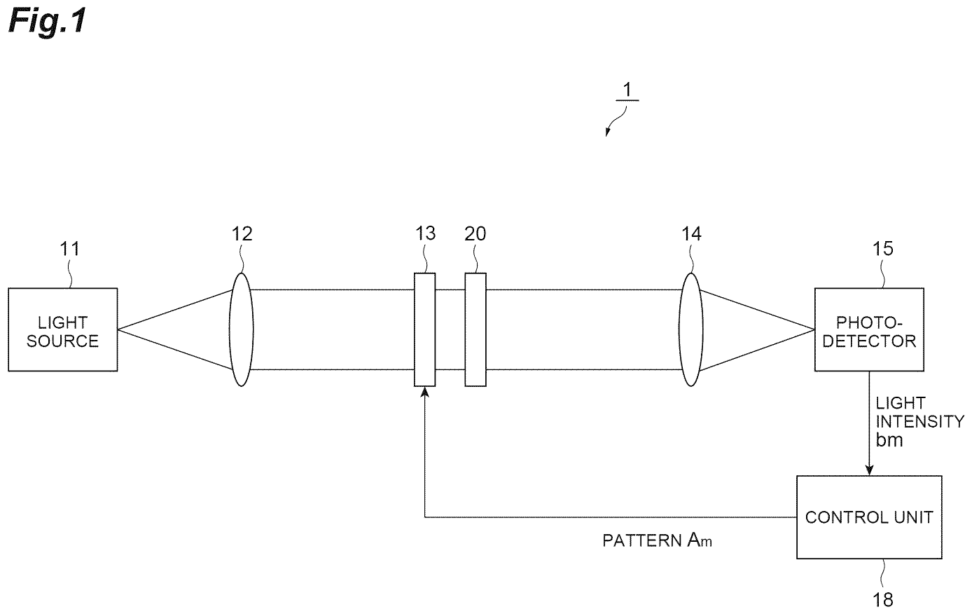

FIG. 1 is a diagram illustrating a configuration of an edge image acquisition apparatus 1. The edge image acquisition apparatus 1 includes a light source 11, an optical system 12, a spatial light modulator 13, an optical system 14, a photodetector 15, and a control unit 18, and is an apparatus for obtaining an image and an edge image of an object 20 by using ghost imaging. The light source 11 outputs light in a wavelength region in which the photodetector 15 has light receiving sensitivity.

The photodetector 15 detects a light intensity of the light output from the light source 11 and passed through the object 20. The photodetector 15 may be set to a photodetector of a single pixel (a point sensor). The spatial light modulator 13 is provided on an optical path between the light source 11 and the object 20, and spatially intensity modulates the light.

The control unit 18 sequentially sets a spatial intensity modulation pattern of the light by the spatial light modulator 13 to each of a plurality of patterns different from each other. The control unit 18 acquires the light intensity detected by the photodetector 15 in a period in which the spatial intensity modulation pattern is set to each of the plurality of patterns. Further, based on the acquired light intensities and the plurality of patterns, the control unit 18 obtains the image of the object 20 by using the ghost imaging, and in addition, obtains the edge image of the object 20. The control unit 18 is configured by using, for example, a computer.

The optical system 12 and the optical system 14 are provided as necessary. For example, the optical system 12 enlarges a beam diameter of the light output from the light source 11, and outputs the light with the enlarged beam diameter to the spatial light modulator 13. The optical system 14 focuses the light arriving after passing through the object 20, and causes the light to be incident on a light receiving unit of the photodetector 15.

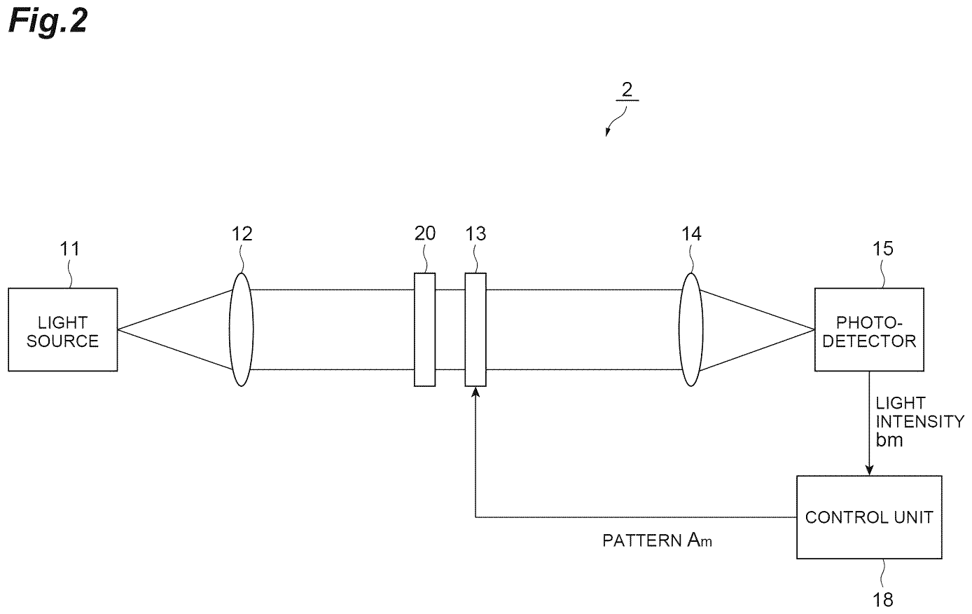

FIG. 2 is a diagram illustrating a configuration of an edge image acquisition apparatus 2. As compared with the edge image acquisition apparatus 1 illustrated in FIG. 1, the edge image acquisition apparatus 2 illustrated in FIG. 2 is different in the position at which the spatial light modulator 13 is provided. In the edge image acquisition apparatus 2 illustrated in FIG. 2, the spatial light modulator 13 is provided on an optical path between the object 20 and the photodetector 15.

The edge image acquisition apparatus for obtaining the image and the edge image of the object by using the ghost imaging may have various configurations other than the configurations illustrated in FIG. 1 and FIG. 2. The spatial light modulator may have a configuration in which each of the plurality of patterns is sequentially set by an electrical signal supplied from the outside, or may have a configuration in which a plate shaped element with a fixed pattern presented is moved in a direction orthogonal to a light propagation direction for sequentially setting each of the plurality of patterns.

The spatial light modulator may have a configuration of a transmission type, or may have a configuration of a reflection type. The spatial light modulator of the reflection type may be a digital micromirror device (DMD). The image of the object may be acquired based on the light transmitted through the object, or the image of the object may be acquired based on the light reflected by the object.

The control unit 18 obtains the image of the object 20 by using the ghost imaging technique, which is described in Non Patent Document 1, as described below.

Out of M patterns different from each other, when a one-dimensional vector representation of an m-th pattern is set to Aₘ, a light intensity bₘ detected by the photodetector 15 in a period in which the above m-th pattern is set is represented by an inner product of the vector Aₘ and the vector t. When a matrix with the m-th pattern as a m-th row is set to A, and the light intensities each detected by the photodetector 15 for each of the plurality of patterns are represented as a vector b, a relationship of the following Formula (10) holds therebetween.

[Formula 10]

b=At (10)

By solving the above equation for t, imaging of the object can be performed. In the ghost imaging technique described in Non Patent Document 1, after performing transforms represented by the following Formula (11) and Formula (12), reconstruction is performed by a correlation calculation represented by the following Formula (13), and thus, the image t* of the object is obtained.

$$[ Formula 11 ]$$

$$\tilde{A} ≡ ( I - \frac{J}{M} ) A \qquad ( 11 )$$

$$[ Formula 12 ]$$

$$\tilde{b} ≡ ( I - \frac{J}{M} ) b \qquad ( 12 )$$

$$[ Formula 13 ]$$

$${t}^{*} = \frac{1}{M {σ}_{A}^{2}} {\tilde{A}}^{T} \tilde{b} \qquad ( 13 )$$

σ_{A}² is a variance of the elements of the matrix A. I is an identity matrix of M rows and M columns. J is a matrix of M rows and M columns in which values of all elements are 1. The image t* of the object 20 which is obtained by the reconstruction by the correlation calculation is represented by the following Formula (14).

$$[ Formula 14 ]$$

$${t}^{*} = \frac{1}{M {σ}_{A}^{2}} {\sum }_{m = 1}^{M} {A}_{m} {b}_{m} - \frac{1}{{M}^{2} {σ}_{A}^{2}} {\sum }_{m = 1}^{M} {A}_{m} {\sum }_{m = 1}^{M} {b}_{m} \qquad ( 14 )$$

In the first comparative example, the edge image of the object is acquired by performing the convolution operation of the kernel h on the image t*. The edge image is represented by the above Formula (3) by using the convolution matrix (the above Formula (4)). The convolution matrix is obtained from the kernel h as described below. In this case, it is assumed that the kernel h is set to a kernel represented by the above Formula (7), and the following description is made for the case in which the number of pixels of the image t* is set to 4×4.

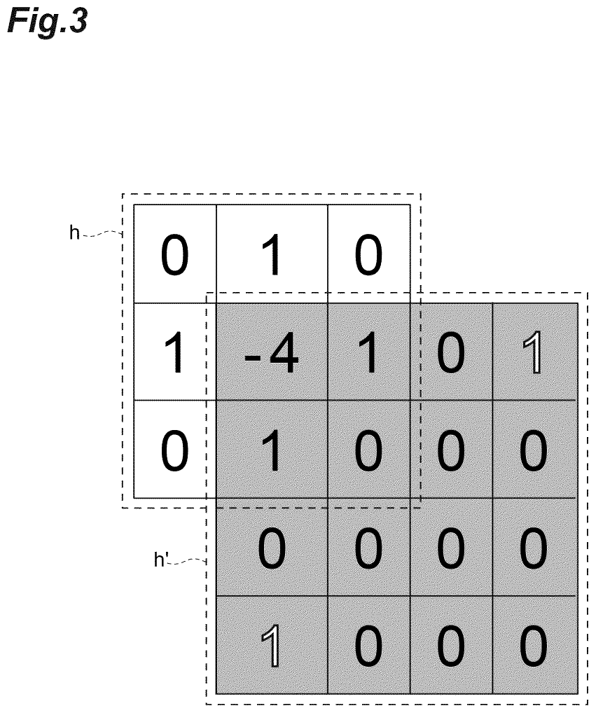

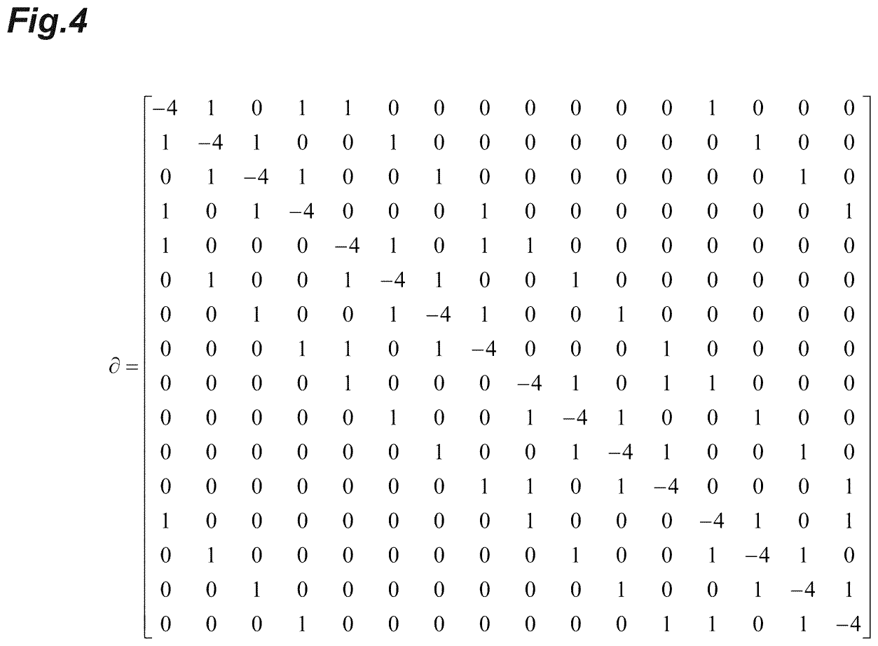

FIG. 3 and FIG. 4 are diagrams for describing a procedure for creating the convolution matrix from the kernel h. A matrix h′ which is shown in FIG. 3 is a 4×4 matrix obtained by taking an element of the kernel h at a center position (a second row and a second column) as an element at a first row and a first column, and extending it vertically and horizontally according to the number of pixels of 4 in the horizontal direction of the image t*.

Further, in the matrix h′, the elements of the kernel h are circulated such that an element at a first row and a second column of h is set as an element at a fourth row and a first column of h′, and an element at a second row and a first column of h is set as an element at a first row and a fourth column of h′. Next, a one-dimensional expansion of the above matrix h′ is set as a first column of the convolution matrix. Further, the other columns of the convolution matrix are determined such that the convolution matrix becomes a doubly block circulant matrix. As a result, the convolution matrix shown in FIG. 4 is obtained.

In the present embodiment, the control unit 18 sequentially sets the spatial intensity modulation pattern of the light by the spatial light modulator 13 to each of the plurality of patterns different from each other as described below, and obtains the image of the object 20.

The control unit 18 prepares a reference pattern in which an intensity modulation amount of the light in each of a plurality of pixels two-dimensionally arranged along a first direction and a second direction (a horizontal direction and a vertical direction) which are orthogonal to each other is randomly set.

The control unit 18 sequentially sets the spatial intensity modulation pattern of the light by the spatial light modulator 13 to each of the plurality of patterns different from each other, by sequentially setting a relative position of the reference pattern with respect to the object 20 along the first direction and the second direction to each of a plurality of positions in units of a pixel pitch. Further, the control unit 18 acquires the light intensity detected by the photodetector 15 in the period in which the spatial intensity modulation pattern is set to each of the plurality of patterns, and obtains the image t* of the object 20 by using the ghost imaging based on the acquired light intensities and the plurality of patterns.

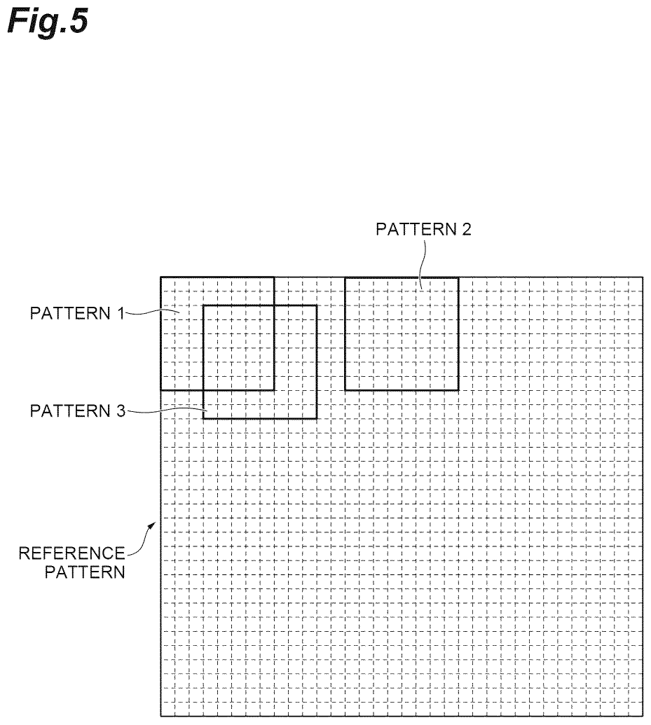

FIG. 5 is a diagram for describing the reference pattern. In this diagram, the smallest unit of a rectangular shape corresponds to a single pixel. A partial region out of the reference pattern (a region having the number of pixels same as the number of pixels of the image t*) is used as each of the spatial intensity modulation patterns of the light by the spatial light modulator 13 (for example, patterns 1 to 3 shown in this diagram). The positions of the respective patterns are different from each other. A difference between the positions of the respective patterns along the first direction is set to an integer multiple of the pixel pitch in the first direction, and a difference between the positions of the respective patterns along the second direction is set to an integer multiple of the pixel pitch in the second direction.

In the present embodiment, the control unit 18 uses the kernel h as described below, and obtains the edge image of the object 20 by the convolution operation between the image t* of the object 20 and the kernel h (that is, by a product of the convolution matrix and the image t of the object 20).

In the kernel h used in this case, out of the plurality of elements two-dimensionally arranged along the first direction and the second direction, a value of an element at a center position is set to non-zero or zero. A value of each of elements at a distance, from the center position along the first direction, of a least common multiple of an interval of the relative position in the first direction, and at a distance, from the center position along the second direction, of a least common multiple of an interval of the relative position in the second direction is set to non-zero or zero. Values of other elements are set to zero. For example, in the case in which the interval of the relative position is set to any one of 2 and 4, the least common multiple of the interval of the relative position is 4. In addition, in the case in which the interval of the relative position is a constant value of d, the least common multiple of the interval of the relative position is d.

In the case in which the interval of the relative position is 1 for both the first direction and the second direction, for example, the kernel h may be set to a kernel represented by the following Formula (15), in addition to the kernel represented by the above Formula (7).

$$[ Formula 15 ]$$

$$h = [ \begin{matrix}1 & 1 & 1 \\ 1 & - 8 & 1 \\ 1 & 1 & 1\end{matrix} ] \qquad ( 15 )$$

In the case in which the interval of the relative position is 2 for both the first direction and the second direction, for example, the kernel h may be set to a kernel represented by the following Formula (16).

$$[ Formula 16 ]$$

$$h = [ \begin{matrix}0 & 0 & 1 & 0 & 0 \\ 0 & 0 & 0 & 0 & 0 \\ 1 & 0 & - 4 & 0 & 1 \\ 0 & 0 & 0 & 0 & 0 \\ 0 & 0 & 1 & 0 & 0\end{matrix} ] \qquad ( 16 )$$

In the case in which the interval of the relative position is 3 for both the first direction and the second direction, for example, the kernel h may be set to a kernel represented by the following Formula (17).

$$[ Formula 17 ]$$

$$h = [ \begin{matrix}0 & 0 & 0 & 1 & 0 & 0 & 0 \\ 0 & 0 & 0 & 0 & 0 & 0 & 0 \\ 0 & 0 & 0 & 0 & 0 & 0 & 0 \\ 1 & 0 & 0 & - 4 & 0 & 0 & 1 \\ 0 & 0 & 0 & 0 & 0 & 0 & 0 \\ 0 & 0 & 0 & 0 & 0 & 0 & 0 \\ 0 & 0 & 0 & 1 & 0 & 0 & 0\end{matrix} ] \qquad ( 17 )$$

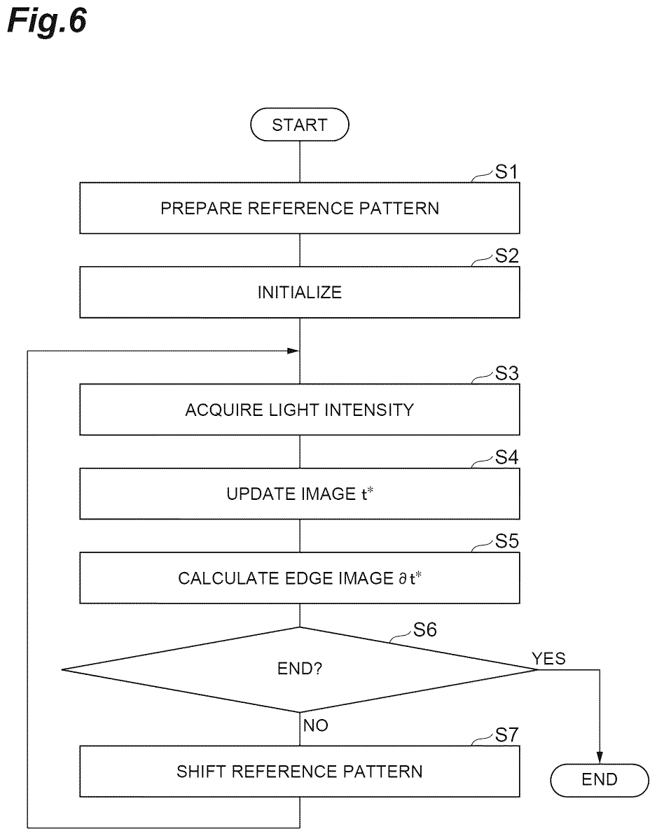

FIG. 6 is a diagram illustrating an example of a flowchart of an edge image acquisition method. In this case, a sum of products Aₘbₘ of the column vector Aₘ of the m-th pattern and the light intensity bₘ is denoted as <Ab>, a sum of the column vectors Aₘ is denoted as <A>, and a sum of the light intensities bₘ is denoted as <b>. The sum means a sum over m=1 to m.

In a step S1, the reference pattern is prepared. In a step S2, each parameter is initialized. Specifically, a pattern number m is set to 1, and respective values of <Ab>, <A>, and <b> are set to 0. In a step S3, the control unit 18 sets the m-th pattern Aₘ, which is a part of the reference pattern, to the spatial light modulator 13, and acquires the light intensity bₘ detected by the photodetector 15 at that time.

In a step S4, the control unit 18 updates <Ab>, <A>, and <b>, respectively, and obtains the image t* of the object by the correlation calculation. That is, Aₘbₘ is added to <Ab>, and the addition result is set as a new <Ab>. Aₘ is added to <A>, and the addition result is set as a new <A>. bₘ is added to <b>, and the addition result is set as a new <b>. Further, by using the above <Ab>, <A>, and <b> after the update, the image t* of the object is calculated. In a step S5, the edge image is obtained by a product of the convolution matrix and the image t* of the object.

In a step S6, the control unit 18 determines whether to end the processing. For example, in the case in which the edge image with sufficiently good image quality is obtained, or in the case in which the predetermined number of patterns is reached, the processing is ended. When it is determined in the step S6 that the processing is not ended yet, in a step S7, a value of m is increased by 1, a next pattern is selected out of the reference pattern, and then the processing returns to the step S3.

In addition, in the above flowchart, the edge image is obtained in the step S5 each time the image t* of the object is updated in the step S4, and further, it is not limited to the above configuration. For example, the edge image may be obtained after the image t of the object is updated by a certain number of repetitions.

Further, by using the technique described in Non Patent Document 4, in the step S4, an image in which a part of components of the image of the object is excluded may be obtained. In this case, all or a part of the excluded components may be added to the obtained image, and the edge image may be obtained by the convolution operation of the image after the addition and the kernel. In addition, without adding all or a part of the excluded components, the edge image may be obtained by the convolution operation of the obtained image and the kernel. By using the above configuration, an error of the obtained image of the object can be reduced, and an error of the edge image can be further reduced.

Next, an error of each pixel value of the edge image of the object obtained in the present embodiment will be described. In this case, the number of pixels of the image of the object is set to Nₓ×N_{y}. It is assumed that there are Mₓ relative positions of the reference pattern with respect to the object 20 along the first direction (the horizontal direction), and that the intervals dₓ of these are constant. It is assumed that there are M_{y} relative positions of the reference pattern with respect to the object 20 along the second direction (the vertical direction), and that the intervals d_{y} of these are constant. It is assumed that the number M of patterns different from each other is Mₓ×M_{y}.

In this case, the matrix A in which each pattern is set as a row can be expressed as a doubly block generalized Toeplitz matrix as described below. In addition, in the matrix A, even when a certain row and another certain row are exchanged, a result of the correlation calculation is the same. In the following description, a block matrix, a Toeplitz matrix, and a doubly block Toeplitz matrix will be described, and then a doubly block generalized Toeplitz matrix will be described.

The block matrix is a matrix in which a plurality of submatrices are two-dimensionally arranged. The following Formula (18) represents the block matrix, and the following Formula (19) represents the one submatrix. In the block matrix, a submatrix in an m_{y}-th row and a j-th column is denoted as A^{my,j} (Formula (18)), and an element in an mₓ-th row and an i-th column of the submatrix A^{my,j} is denoted as A^{my,j}_{mx,i} (Formula (19)). In addition, mₓ is an integer of 1 or more and Mₓ or less, m_{y} is an integer of 1 or more and M_{y} or less, i is an integer of 1 or more and Nₓ or less, and j is an integer of 1 or more and N_{y} or less.

$$[ Formula 18 ]$$

$$[ \begin{matrix}{A}^{1 , 1} & {A}^{1 , 2} & * & * \\ {A}^{2 , 1} & * & * & * \\ * & * & {A}^{{m}_{y} , j} & * \\ * & * & * & *\end{matrix} ] \qquad ( 18 )$$

$$[ Formula 19 ]$$

$$[ \begin{matrix}{A}_{1 , 1}^{{m}_{y} , j} & {A}_{1 , 2}^{{m}_{y} , j} & * & * \\ {A}_{2 , 1}^{{m}_{y} , j} & * & * & * \\ * & * & {A}_{{m}_{x} , i}^{{m}_{y} , j} & * \\ * & * & * & *\end{matrix} ] \qquad ( 19 )$$

The Toeplitz matrix is a matrix in which values of the elements are constant along each descending diagonal from upper left to lower right. A circulant matrix is a type of the Toeplitz matrix. In the Toeplitz matrix, the following Formula (20) holds between the elements.

[Formula 20]

Aₘ_{ₓ}_{,j}=Aₘ_{ₓ}_{+1,j+1} (20)

The doubly block Toeplitz matrix is a matrix obtained by extending the Toeplitz matrix to the block matrix. In the doubly block Toeplitz matrix, the following Formula (21) holds between the elements.

$$[ Formula 21 ]$$

$${A}_{{m}_{x} , i}^{{m}_{y} , j} = {A}_{{m}_{x} + 1 , i + 1}^{{m}_{y} , j} = {A}_{{m}_{x} , i}^{{m}_{y} + 1 , j + 1} \qquad ( 21 )$$

The doubly block generalized Toeplitz matrix is a matrix obtained by generalizing the doubly block Toeplitz matrix, and is defined as a matrix in which the following Formula (22) holds between the elements. Each of dₓ and d_{y} is an integer of 1 or more. In the case in which both values of dₓ and d_{y} are 1, the above matrix coincides with the doubly block Toeplitz matrix.

$$[ Formula 22 ]$$

$${A}_{{m}_{x} , i}^{{m}_{y} , j} = {A}_{{m}_{x} + 1 , i + {d}_{x}}^{{m}_{y} , j} = {A}_{{m}_{x} , i}^{{m}_{y} + 1 , j + {d}_{y}} \qquad ( 22 )$$

In the case in which the interval dₓ of the relative position of the reference pattern with respect to the object 20 along the first direction (the horizontal direction) is constant, and the interval d_{y} of the relative position of the reference pattern with respect to the object 20 along the second direction (the vertical direction) is constant, the matrix A can be set to the doubly block generalized Toeplitz matrix, by appropriately setting the setting order of the M patterns, or, even when the setting order of the M patterns is arbitrary, by appropriately exchanging a certain row and another certain row in the matrix A.

In the case in which the matrix A is the doubly block generalized Toeplitz matrix, the error of the image t* obtained by the reconstruction by the correlation calculation is represented by the following Formula (23). By using the Schwarz inequality, a relationship of the following Formula (24) is obtained. In this case, t and t* are expressed in a blocked notation.

$$[ Formula 23 ]$$

$$V [ {( {t}^{*} )}_{i}^{j} ] ≃ \frac{{‖ t ‖}_{2}^{2}}{M} + \frac{1}{{M}^{2}} {\sum }_{{l}_{x} , {l}_{y}} max ( {M}_{x} - \vert {l}_{x} {d}_{x} \vert , 0 ) max ( {M}_{y} - \vert {l}_{y} {d}_{y} \vert , 0 ) {t}_{i - {l}_{x} {d}_{x}}^{j - {l}_{y} {d}_{y}} {t}_{i + {l}_{x} {d}_{x}}^{j + {l}_{y} {d}_{y}} \qquad ( 23 )$$

$$where$$

$$i ∈ [ 1 , {N}_{x} ] , j ∈ [ 1 , {N}_{y} ] , i \pm {l}_{x} {d}_{x} ∈ [ 1 , {N}_{x} ] , j \pm {l}_{y} {d}_{y} ∈ [ 1 , {N}_{y} ]$$

$$[ Formula 24 ]$$

$$V [ {( {t}^{*} )}_{i}^{j} ] < \frac{2 {‖ t ‖}_{2}^{2}}{M} \qquad ( 24 )$$

In the present embodiment, the plurality of patterns are sequentially set by shifting the reference pattern, and thus, the above plurality of patterns are temporally correlated, and each pixel value of the image t* obtained by the reconstruction has correlation between the pixels. The above fact causes artifact generation in the image t. In addition, for a sparse image, a signal amount obtained when the pattern is shifted has only relatively weak correlation with a signal amount in preceding and succeeding measurements, and thus, the correlation between the pixels is reduced. The edge image obtained by performing the convolution operation on the image t is sparse, and thus, the correlation between the pixels becomes small in the edge image.

A relationship between the image t* and the true image t is represented by the following Formula (25). The edge image obtained by performing the convolution operation on the image t* is represented by the following Formula (26).

$$[ Formula 25 ]$$

$${t}^{*} = \frac{1}{M {σ}_{A}^{2}} {\tilde{A}}^{T} \tilde{b} = \frac{1}{M {σ}_{A}^{2}} {\tilde{A}}^{T} \tilde{A} t \qquad ( 25 )$$

$$[ Formula 26 ]$$

$$\partial {t}^{*} = \frac{1}{M {σ}_{A}^{2}} \partial {\tilde{A}}^{T} \tilde{A} t \qquad ( 26 )$$

In the case in which the matrix A is the doubly block generalized Toeplitz matrix, for the convolution integration satisfying specific conditions, the following Formula (27) holds. By using this, the above Formula (26) is represented by the following Formula (28).

### [Formula 27]

∂Ã^{T}Ã=Ã^{T}Ã∂ (27)

$$[ Formula 28 ]$$

$$\partial {t}^{*} ≃ \frac{1}{M {σ}_{4}^{2}} {\tilde{A}}^{T} \tilde{A} \partial t \qquad ( 28 )$$

That is, the edge image (Formula (28)) obtained by performing the convolution integration satisfying the specific conditions on the image t* approximately coincides with the edge image which is reconstructed by performing the ghost imaging on the edge image (Formula (2)) with respect to the original image t. Therefore, similarly to the above Formula (23) and Formula (24), the error of the edge image (Formula (28)) is represented by the following Formula (29).

$$[ Formula 29 ]$$

$$V [ {( \partial {t}^{*} )}_{i}^{j} ] ≃ \frac{{‖ \partial t ‖}_{2}^{2}}{M} + \frac{1}{{M}^{2}} {\sum }_{{l}_{x} , {l}_{y}} max ( {M}_{x} - \vert {l}_{x} {d}_{x} \vert , 0 ) max ( {M}_{y} - \vert {l}_{y} {d}_{y} \vert , 0 ) {( \partial t )}_{i - {l}_{x} {d}_{x}}^{j - {l}_{y} {d}_{y}} {( \partial t )}_{i + {l}_{x} {d}_{x}}^{j + {l}_{y} {d}_{y}} < \frac{2 {‖ \partial t ‖}_{2}^{2}}{M} \qquad ( 29 )$$

In this case, the “the convolution integration satisfying the specific conditions” which is described above is the convolution integration using the kernel h which satisfies the following two conditions. A first condition is that, when the size of the kernel h is set to Kₓ×K_{y}, Kₓ is sufficiently smaller than each of Nₓ and Mₓ, and K_{y} is sufficiently smaller than each of N_{y} and M_{y}. In many cases, the above first condition is easily satisfied.

A second condition is the condition of the kernel h described above, that is, out of the plurality of elements two-dimensionally arranged along the first direction and the second direction, a value of an element at the center position is set to non-zero or zero, a value of each of elements at the distance, from the center position along the first direction, of the least common multiple of the interval of the relative position in the first direction, and at the distance, from the center position along the second direction, of the least common multiple of the interval of the relative position in the second direction is set to non-zero or zero, and values of other elements are set to zero.

In the case in which the above two conditions are satisfied, the error of the edge image which is obtained in the present embodiment is smaller than the error of the edge image which is obtained in the second comparative example.

Next, simulation results will be described. In each of first to third simulations described below, Nₓ=N_{y}=128 and Mₓ=M_{y}=130 were used.

In the first simulation and the second simulation, in order to simulate implementation by using the DMD, each pixel value of the reference pattern was determined by a Bernoulli distribution with a success probability of 0.5. In the third simulation, in order to simulate implementation by using laser speckle, each pixel value was determined by a Bernoulli distribution with a success probability of 0.1, and then a two-dimensional normal distribution having a standard deviation of 1.5 in each of a horizontal direction and a vertical direction was convolved to obtain the reference pattern.

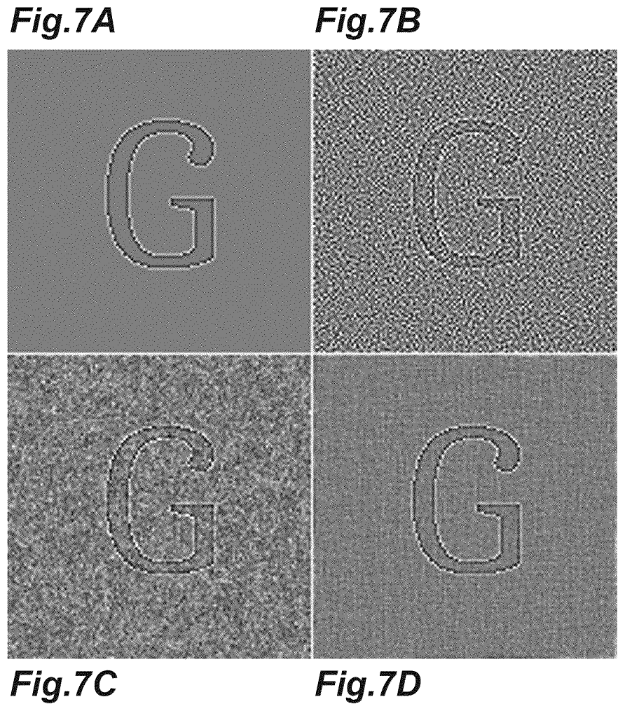

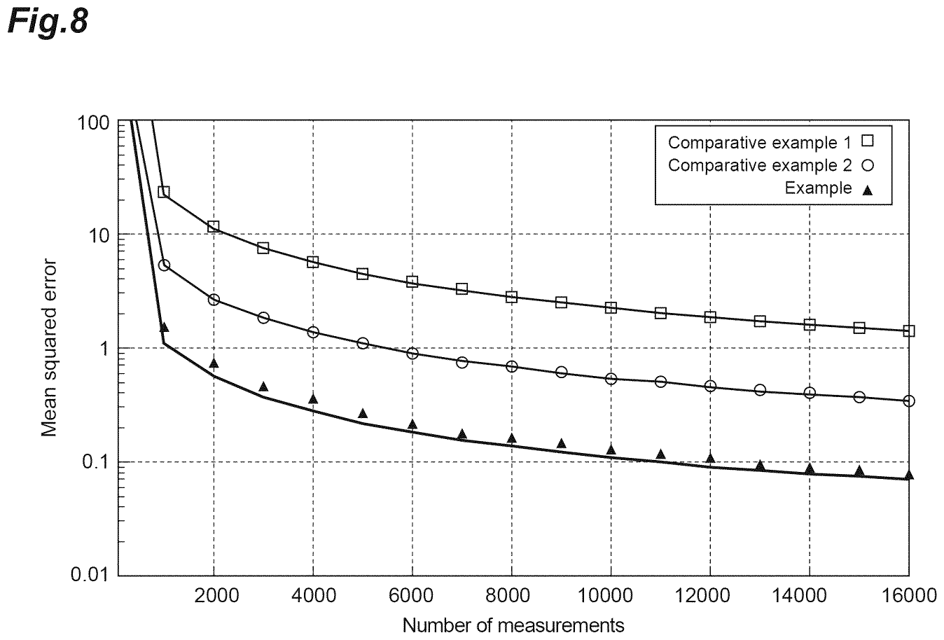

In the first simulation, it is set to dₓ=d_{y}=1, and the kernel h of the above Formula (7) is used. FIG. 7A to FIG. 7D and FIG. 8 are diagrams showing the results of the first simulation. FIG. 7A is a diagram showing the original edge image of the object. FIG. 7B is a diagram showing the edge image obtained in the first comparative example. FIG. 7C is a diagram showing the edge image obtained in the second comparative example. FIG. 7D is a diagram showing the edge image obtained by the edge image acquisition method according to the present embodiment. FIG. 8 is a graph showing a relationship between the number of measurements and the squared error of each pixel value.

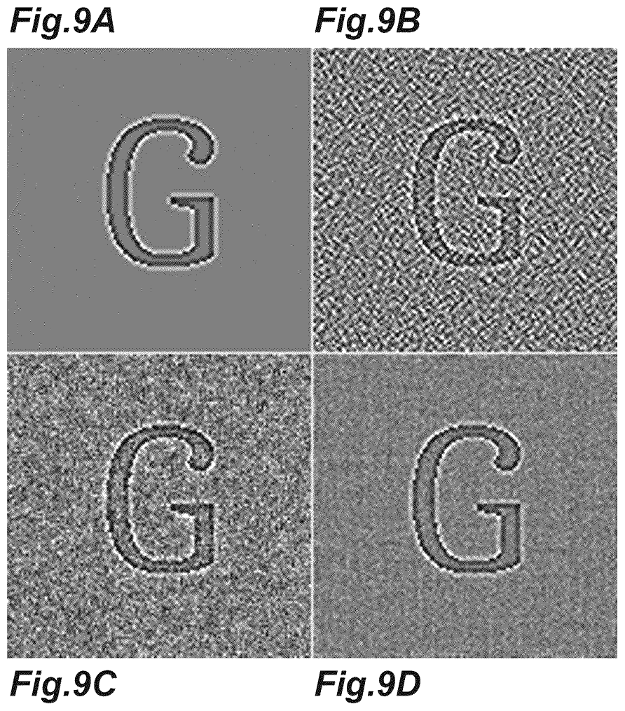

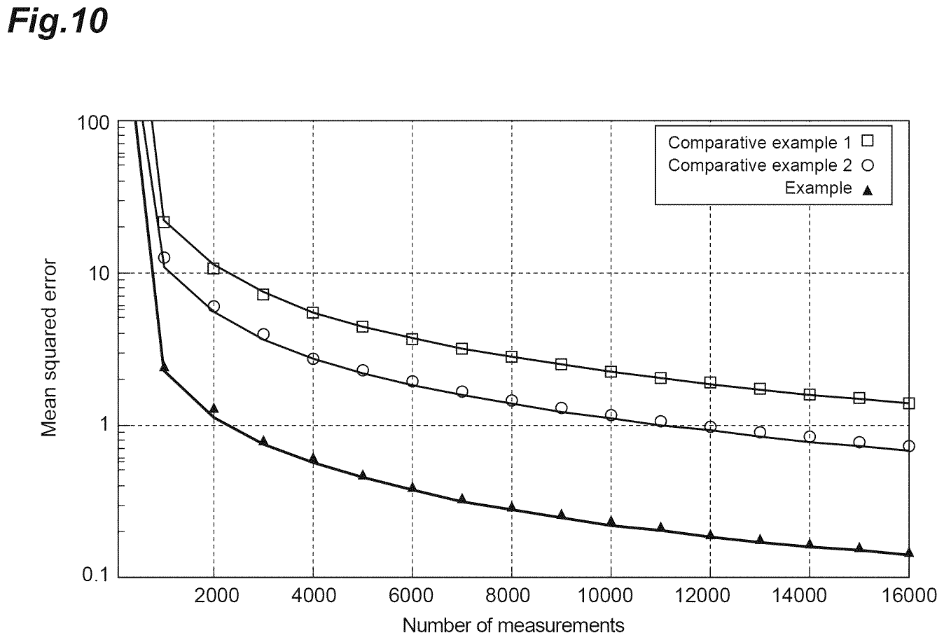

In the second simulation, it is set to dₓ=d_{y}=2, and the kernel h of the above Formula (16) is used. FIG. 9A to FIG. 9D and FIG. 10 are diagrams showing the results of the second simulation. FIG. 9A is a diagram showing the original edge image of the object. FIG. 9B is a diagram showing the edge image obtained in the first comparative example. FIG. 9C is a diagram showing the edge image obtained in the second comparative example. FIG. 9D is a diagram showing the edge image obtained by the edge image acquisition method according to the present embodiment. FIG. 10 is a graph showing a relationship between the number of measurements and the squared error of each pixel value.

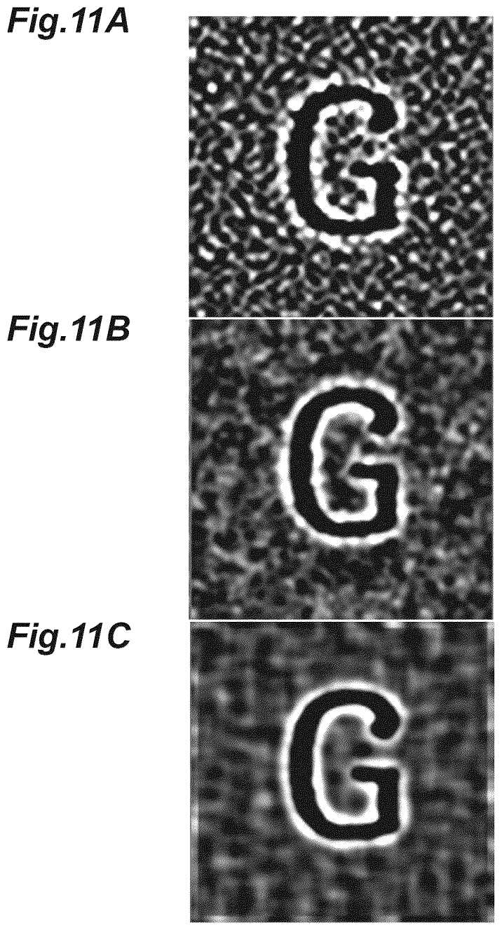

In the third simulation, it is set to dₓ=d_{y}=3, and the kernel h of the above Formula (17) is used. FIG. 11A to FIG. 11C are diagrams showing the results of the third simulation. FIG. 11A is a diagram showing the edge image obtained in the first comparative example. FIG. 11B is a diagram showing the edge image obtained in the second comparative example. FIG. 11C is a diagram showing the edge image obtained by the edge image acquisition method according to the present embodiment.

As shown by the simulation results described above, the edge image obtained by the edge image acquisition method according to the present embodiment has a smaller error than in the cases of the first comparative example and the second comparative example.

The edge image acquisition apparatus and the edge image acquisition method are not limited to the embodiments and configuration examples described above, and various modifications are possible.

The edge image acquisition apparatus of a first aspect according to the above embodiment includes (1) a light source configured to output light; (2) a photodetector configured to detect a light intensity of the light output from the light source and passed through an object; (3) a spatial light modulator provided on an optical path between the light source and the photodetector, and configured to spatially intensity modulate the light; and (4) a control unit configured to sequentially set a spatial intensity modulation pattern of the light by the spatial light modulator to each of a plurality of patterns different from each other, acquire the light intensity detected by the photodetector in a period in which the spatial intensity modulation pattern is set to each of the plurality of patterns, and obtain an image and an edge image of the object by using ghost imaging based on the acquired light intensities and the plurality of patterns, and the control unit is configured to (a) use a reference pattern in which an intensity modulation amount of the light in each of a plurality of pixels two-dimensionally arranged along a first direction and a second direction which are orthogonal to each other is randomly set, (b) sequentially set the spatial intensity modulation pattern to each of the plurality of patterns by sequentially setting a relative position of the reference pattern with respect to the object along the first direction and the second direction to each of a plurality of positions in units of a pixel pitch, acquire the light intensity detected by the photodetector in the period in which the spatial intensity modulation pattern is set to each of the plurality of patterns, and obtain the image of the object by using the ghost imaging based on the acquired light intensities and the plurality of patterns, (c) use a kernel in which, out of a plurality of elements two-dimensionally arranged along the first direction and the second direction, a value of an element at a center position is set to non-zero or zero, a value of each of elements at a distance from the center position along the first direction of a least common multiple of an interval of the relative position in the first direction, and at a distance from the center position along the second direction of a least common multiple of an interval of the relative position in the second direction is set to non-zero or zero, and values of other elements are set to zero, and (d) obtain the edge image of the object by a convolution operation of the image of the object and the kernel.

In the edge image acquisition apparatus of a second aspect, in the configuration of the above first aspect, the control unit may be configured to obtain an image in which a part of components of the image of the object is excluded by using the ghost imaging, add all or a part of the excluded components to the obtained image, and obtain the edge image by the convolution operation of the image after addition and the kernel.

In the edge image acquisition apparatus of a third aspect, in the configuration of the above first aspect, the control unit may be configured to obtain an image in which a part of components of the image of the object is excluded by using the ghost imaging, and obtain the edge image by the convolution operation of the obtained image and the kernel.

The edge image acquisition method of a first aspect according to the above embodiment uses (1) a light source configured to output light; (2) a photodetector configured to detect a light intensity of the light output from the light source and passed through an object; and (3) a spatial light modulator provided on an optical path between the light source and the photodetector, and configured to spatially intensity modulate the light, and (4) the method includes sequentially setting a spatial intensity modulation pattern of the light by the spatial light modulator to each of a plurality of patterns different from each other, acquiring the light intensity detected by the photodetector in a period in which the spatial intensity modulation pattern is set to each of the plurality of patterns, and obtaining an image and an edge image of the object by using ghost imaging based on the acquired light intensities and the plurality of patterns, and (a) a reference pattern in which an intensity modulation amount of the light in each of a plurality of pixels two-dimensionally arranged along a first direction and a second direction which are orthogonal to each other is randomly set is used, (b) the spatial intensity modulation pattern is sequentially set to each of the plurality of patterns by sequentially setting a relative position of the reference pattern with respect to the object along the first direction and the second direction to each of a plurality of positions in units of a pixel pitch, the light intensity detected by the photodetector is acquired in the period in which the spatial intensity modulation pattern is set to each of the plurality of patterns, and the image of the object is obtained by using the ghost imaging based on the acquired light intensities and the plurality of patterns, (c) a kernel in which, out of a plurality of elements two-dimensionally arranged along the first direction and the second direction, a value of an element at a center position is set to non-zero or zero, a value of each of elements at a distance from the center position along the first direction of a least common multiple of an interval of the relative position in the first direction, and at a distance from the center position along the second direction of a least common multiple of an interval of the relative position in the second direction is set to non-zero or zero, and values of other elements are set to zero is used, and (d) the edge image of the object is obtained by a convolution operation of the image of the object and the kernel.

In the edge image acquisition method of a second aspect, in the configuration of the above first aspect, an image in which a part of components of the image of the object is excluded may be obtained by using the ghost imaging, all or a part of the excluded components may be added to the obtained image, and the edge image may be obtained by the convolution operation of the image after addition and the kernel.

In the edge image acquisition method of a third aspect, in the configuration of the above first aspect, an image in which a part of components of the image of the object is excluded may be obtained by using the ghost imaging, and the edge image may be obtained by the convolution operation of the obtained image and the kernel.

The present invention can be used as an edge image acquisition apparatus and an edge image acquisition method capable of acquiring an edge image of an object in which an error is reduced by using ghost imaging.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An edge image acquisition apparatus comprising:
a light source configured to output light;
a photodetector configured to detect a light intensity of the light output from the light source and passed through an object;
a spatial light modulator provided on an optical path between the light source and the photodetector, and configured to spatially intensity modulate the light; and
a control unit configured to sequentially set a spatial intensity modulation pattern of the light by the spatial light modulator to each of a plurality of patterns different from each other, acquire the light intensity detected by the photodetector in a period in which the spatial intensity modulation pattern is set to each of the plurality of patterns, and obtain an image and an edge image of the object by using ghost imaging based on the acquired light intensities and the plurality of patterns, wherein
the control unit is configured to
use a reference pattern in which an intensity modulation amount of the light in each of a plurality of pixels two-dimensionally arranged along a first direction and a second direction which are orthogonal to each other is randomly set,
sequentially set the spatial intensity modulation pattern to each of the plurality of patterns by sequentially setting a relative position of the reference pattern with respect to the object along the first direction and the second direction to each of a plurality of positions in units of a pixel pitch, acquire the light intensity detected by the photodetector in the period in which the spatial intensity modulation pattern is set to each of the plurality of patterns, and obtain the image of the object by using the ghost imaging based on the acquired light intensities and the plurality of patterns,
use a kernel in which, out of a plurality of elements two-dimensionally arranged along the first direction and the second direction, a value of an element at a center position is set to non-zero or zero, a value of each of elements at a distance from the center position along the first direction of a least common multiple of an interval of the relative position in the first direction, and at a distance from the center position along the second direction of a least common multiple of an interval of the relative position in the second direction is set to non-zero or zero, and values of other elements are set to zero, and
obtain the edge image of the object by a convolution operation of the image of the object and the kernel.

2. The edge image acquisition apparatus according to claim 1, wherein the control unit is configured to obtain an image in which a part of components of the image of the object is excluded by using the ghost imaging, add all or a part of the excluded components to the obtained image, and obtain the edge image by the convolution operation of the image after addition and the kernel.

3. The edge image acquisition apparatus according to claim 1, wherein the control unit is configured to obtain an image in which a part of components of the image of the object is excluded by using the ghost imaging, and obtain the edge image by the convolution operation of the obtained image and the kernel.

4. An edge image acquisition method using:
a light source configured to output light;
a photodetector configured to detect a light intensity of the light output from the light source and passed through an object; and
a spatial light modulator provided on an optical path between the light source and the photodetector, and configured to spatially intensity modulate the light,
the method comprising:
sequentially setting a spatial intensity modulation pattern of the light by the spatial light modulator to each of a plurality of patterns different from each other, acquiring the light intensity detected by the photodetector in a period in which the spatial intensity modulation pattern is set to each of the plurality of patterns, and obtaining an image and an edge image of the object by using ghost imaging based on the acquired light intensities and the plurality of patterns, wherein
a reference pattern in which an intensity modulation amount of the light in each of a plurality of pixels two-dimensionally arranged along a first direction and a second direction which are orthogonal to each other is randomly set is used,
the spatial intensity modulation pattern is sequentially set to each of the plurality of patterns by sequentially setting a relative position of the reference pattern with respect to the object along the first direction and the second direction to each of a plurality of positions in units of a pixel pitch, the light intensity detected by the photodetector is acquired in the period in which the spatial intensity modulation pattern is set to each of the plurality of patterns, and the image of the object is obtained by using the ghost imaging based on the acquired light intensities and the plurality of patterns,
a kernel in which, out of a plurality of elements two-dimensionally arranged along the first direction and the second direction, a value of an element at a center position is set to non-zero or zero, a value of each of elements at a distance from the center position along the first direction of a least common multiple of an interval of the relative position in the first direction, and at a distance from the center position along the second direction of a least common multiple of an interval of the relative position in the second direction is set to non-zero or zero, and values of other elements are set to zero is used, and
the edge image of the object is obtained by a convolution operation of the image of the object and the kernel.

5. The edge image acquisition method according to claim 4, wherein an image in which a part of components of the image of the object is excluded is obtained by using the ghost imaging, all or a part of the excluded components are added to the obtained image, and the edge image is obtained by the convolution operation of the image after addition and the kernel.

6. The edge image acquisition method according to claim 4, wherein an image in which a part of components of the image of the object is excluded is obtained by using the ghost imaging, and the edge image is obtained by the convolution operation of the obtained image and the kernel.
